(19) United States
(12) Patent Application Publication
(10) Pub. No.: US 2002/0188443 A1
(43) Pub. Date: Dec. 12, 2002

(54) System, method and computer program product for comprehensive playback using a vocal player

(76) Inventors: Gopi Reddy, Sunnyvale, CA (US); Khang Pham, San Jose, CA (US); Khiem Pham, Stockton, CA (US)

Correspondence Address: SILICON VALLEY INTELLECTUAL PROPERTY GROUP, P.O. BOX 721120, SAN JOSE, CA, 95172-1120, US

(21) Appl. No.: 09/853,350

(22) Filed: May 11, 2001

(51) Int. Cl. G10L 15/00

(52) U.S. Cl. 704/231

(57) ABSTRACT

A system, method and computer program product are provided for recording and playing back a sequence of utterances. Initially, a plurality of utterances is monitored utilizing a network. Thereafter, the utterances and timing data representative of pauses between the utterances are recorded in a file. At a later time, the utterances in the file are parsed and a sequence of the utterances is reconstructed with the pauses utilizing the timing data. The reconstructed sequence of utterances is then played back.

### FIELD OF THE INVENTION

The present invention relates to speech recognition, and more particularly to tuning and testing a speech recognition system.

### BACKGROUND OF THE INVENTION

Techniques for accomplishing automatic speech recognition (ASR) are well known. Among known ASR techniques are those that use grammars. A grammar is a representation of the language or phrases expected to be used or spoken in a given context. In one sense, then, ASR grammars typically constrain the speech recognizer to a vocabulary that is a subset of the universe of potentially-spoken words; and grammars may include subgrammars. An ASR grammar rule can then be used to represent the set of “phrases” or combinations of words from one or more grammars or subgrammars that may be expected in a given context. “Grammar” may also refer generally to a statistical language model (where a model represents phrases), such as those used in language understanding systems.

ASR systems have greatly improved in recent years as better algorithms and acoustic models are developed, and as more computer power can be brought to bear on the task. An ASR system running on an inexpensive home or office computer with a good microphone can take free-form dictation, as long as it has been pre-trained for the speaker's voice. Over the phone, and with no speaker training, a speech recognition system needs to be given a set of speech grammars that tell it what words and phrases it should expect. With these constraints a surprisingly large set possible utterances can be recognized (e.g., a particular mutual fund name out of thousands). Recognition over mobile phones in noisy environments does require more tightly pruned and carefully crafted speech grammars, however. Today there are many commercial uses of ASR in dozens of languages, and in areas as disparate as voice portals, finance, banking, telecommunications, and brokerages.

Advances are also being made in speech synthesis, or text-to-speech (TTS). Many of today's TTS systems still sound like “robots”, and can be hard to listen to or even at times incomprehensible. However, waveform concatenation speech synthesis is now being deployed. In this technique, speech is not completely generated from scratch, but is assembled from libraries of pre-recorded waveforms. The results are promising.

In a standard speech recognition/synthesis system, a database of utterances is maintained for administering a predetermined service. In one example of operation, a user may utilize a telecommunication network to communicate utterances to the system. In response to such communication, the utterances are recognized utilizing speech recognition, and processing takes place utilizing the recognized utterances. Thereafter, synthesized speech is output in accordance with the processing. In one particular application, a user may verbally communicate a street address to the speech recognition system, and driving directions may be returned utilizing synthesized speech.

### DISCLOSURE OF THE INVENTION

A system, method and computer program product are provided for recording and playing back a sequence of utterances. Initially, a plurality of utterances is monitored utilizing a network. Thereafter, the utterances and timing data representative of pauses between the utterances are recorded in a file. At a later time, the utterances in the file are parsed and a sequence of the utterances is reconstructed with the pauses utilizing the timing data. The reconstructed sequence of utterances is then played back.

In one embodiment of the present invention, the utterances may be monitored during an interaction between a user and an automated service. As such, the utterances may include any of those generated by the user and/or the automated service during the interaction. For example, the utterances may include a prompt for the user, a string of user utterances received from the user, and a reply to the string of user utterances. In particular, a user may be prompted with a prompt utilizing network, and the string of user utterances may be received from the user in response to the prompt utilizing the network. Thereafter, a reply to the string of user utterances may be transmitted to the user utilizing the network.

In another embodiment of the present invention, the utterances may be played back based on user-configured criteria. Still yet, the reconstructed sequence of utterances may be played back for facilitating the tuning of an associated speech recognition process. Such speech recognition process may be tuned by identifying utterances that are difficult to recognize, and generating alternate phonetic spellings, etc.

In another embodiment of the present invention, the utterances of the sequence may each represent a state. Further, the utterances may be played back based on the state thereof. As an option, the utterances of the sequence may be capable of being selectively played back without the pauses. As yet another option, the utterances of the sequence may be capable of being selectively played back based on a user who submitted the utterances, a time the utterances were submitted, and/or an application in association with which the utterances were submitted.

In yet another embodiment of the present invention, any difficulty of the speech recognition process with recognizing the utterances may be detected. Further, an administrator may be notified of the difficulty, and the sequence of utterances may be played back thereto. Optionally, utterances of the sequence may be selectively played back utilizing a graphical user interface.

### BRIEF DESCRIPTION OF THE DRAWINGS

FIG. 1 illustrates an exemplary environment in which the present invention may be implemented;

FIG. 2 shows a representative hardware environment associated with the various components of FIG. 1;

FIG. 3 illustrates a method for providing a speech recognition process;

FIG. 4 illustrates a web-based interface which interacts with a database to enable and coordinate an audio transcription effort;

FIG. 5 is a flowchart illustrating a method for recording and playing back an interaction between a user and an automated service;

FIG. 6 illustrates a graphical user interface for allowing a user to selectively play back utterances, in accordance with one embodiment of the present invention;

FIG. 7 illustrates a graphical user interface for searching for stored utterances;

FIG. 8 illustrates a graphical user interface by which a user can configure the interface of FIG. 6;

FIG. 9 illustrates a graphical user interface for tagging a bug to be fixed, in accordance with one embodiment of the present invention;

FIG. 10 illustrates a graphical user interface that shows the manner in which the various logs associated with each call may be displayed;

FIG. 11 illustrates the manner in which the columns and rows of the main graphical user interface can be sorted interactively to determine a particular call to utilize, and how any of the fields can be dynamically resized; and

FIG. 12 illustrates a graphical user interface that includes a log feeder and a log replicator.

### DESCRIPTION OF THE PREFERRED EMBODIMENTS

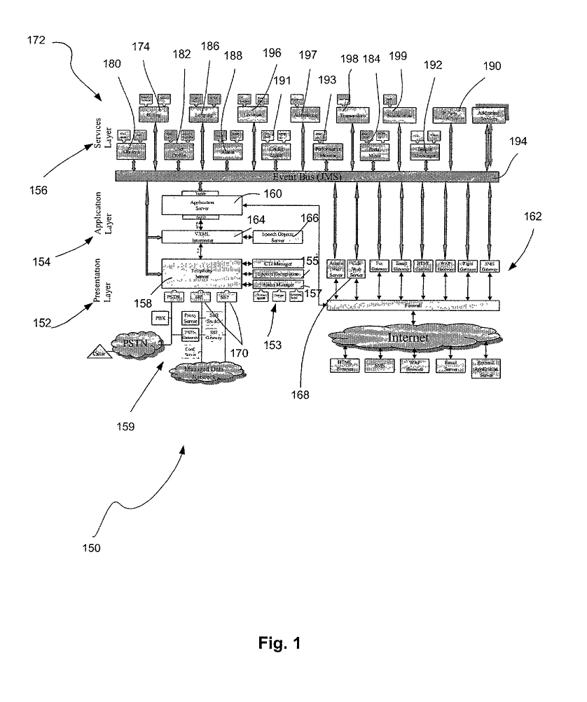

FIG. 1 illustrates one exemplary platform 150 on which the present invention may be implemented. The present platform 150 is capable of supporting voice applications that provide unique business services. Such voice applications may be adapted for consumer services or internal applications for employee productivity.

The present platform of FIG. 1 provides an end-to-end solution that manages a presentation layer 152, application logic 154, information access services 156, and telecom infrastructure 159. With the instant platform, customers can build complex voice applications through a suite of customized applications and a rich development tool set on an application server 160. The present platform 150 is capable of deploying applications in a reliable, scalable manner, and maintaining the entire system through monitoring tools.

The present platform 150 is multi-modal in that it facilitates information delivery via multiple mechanisms 162, i.e. Voice, Wireless Application Protocol (WAP), Hypertext Mark-up Language (HTML), Facsimile, Electronic Mail, Pager, and Short Message Service (SMS). It further includes a VoiceXML interpreter 164 that is fully compliant with the VoiceXML 1.0 specification, written entirely in Java®, and supports Nuance® SpeechObjects 166.

Yet another feature of the present platform 150 is its modular architecture, enabling “plug-and-play” capabilities. Still yet, the instant platform 150 is extensible in that developers can create their own custom services to extend the platform 150. For further versatility, Java® based components are supported that enable rapid development, reliability, and portability. Another web server 168 supports a web-based development environment that provides a comprehensive set of tools and resources which developers may need to create their own innovative speech applications.

Support for SIP and SS7 (Signaling System 7) is also provided. Backend Services 172 are also included that provide value added functionality such as content management 180 and user profile management 182. Still yet, there is support for external billing engines 174 and integration of leading edge technologies from Nuance®, Oracle®, Cisco®, Natural Microsystems®, and Sun Microsystems®.

More information will now be set forth regarding the application layer 154, presentation layer 152, and services layer 156.

Application Layer 154

The application layer 154 provides a set of reusable application components as well as the software engine for their execution. Through this layer, applications benefit from a reliable, scalable, and high performing operating environment. The application server 160 automatically handles lower level details such as system management, communications, monitoring, scheduling, logging, and load balancing. Some optional features associated with each of the various components of the application layer 154 will now be set forth.

Application Server 160

A high performance web/JSP server that hosts the business and presentation logic of applications.

High performance, load balanced, with failover.

Contains reusable application components and ready to use applications.

Hosts Java Servlets and JSP's for custom applications.

Provides easy to use taglib access to platform services.

VXML Interpreter 164

Executes VXML applications

VXML 1.0 compliant

Can execute applications hosted on either side of the firewall.

Extensions for easy access to system services such as billing.

Extensible—allows installation of custom VXML tag libraries and speech objects.

Provides access to SpeechObjects 166 from VXML.

Integrated with debugging and monitoring tools.

Written in Java®.

Speech Objects Server 166

Hosts SpeechObjects based components.

Provides a platform for running SpeechObjects based applications.

Contains a rich library of reusable SpeechObjects.

Services Layer 156

The services layer 156 simplifies the development of voice applications by providing access to modular value-added services. These backend modules deliver a complete set of functionality, and handle low level processing such as error checking. Examples of services include the content 180, user profile 182, billing 174, and portal management 184 services. By this design, developers can create high performing, enterprise applications without complex programming. Some optional features associated with each of the various components of the services layer 156 will now be set forth.

Content 180

Manages content feeds and databases such as weather reports, stock quotes, and sports.

Ensures content is received and processed appropriately.

Provides content only upon authenticated request.

Communicates with logging service 186 to track content usage for auditing purposes.

Supports multiple, redundant content feeds with automatic failover.

Sends alarms through alarm service 188.

User Profile 182

Manages user database

Can connect to a 3^{rd} party user database 190. For example, if a customer wants to leverage his/her own user database, this service will manage the connection to the external user database.

Provides user information upon authenticated request.

Alarm 188

Provides a simple, uniform way for system components to report a wide variety of alarms.

Allows for notification (Simply Network Management Protocol (SNMP), telephone, electronic mail, pager, facsimile, SMS, WAP push, etc.) based on alarm conditions.

Allows for alarm management (assignment, status tracking, etc) and integration with trouble ticketing and/or helpdesk systems.

Allows for integration of alarms into customer premise environments.

Configuration Management 191

Maintains the configuration of the entire system.

Performance Monitor 193

Provides real time monitoring of entire system such as number of simultaneous users per customer, number of users in a given application, and the uptime of the system.

Enables customers to determine performance of system at any instance.

Portal Management 184

The portal management service 184 maintains information on the configuration of each voice portal and enables customers to electronically administer their voice portal through the administration web site.

Portals can be highly customized by choosing from multiple applications and voices. For example, a customer can configure different packages of applications i.e. a basic package consisting of 3 applications for $4.95, a deluxe package consisting of 10 applications for $9.95, and premium package consisting of any 20 applications for $14.95.

Instant Messenger 192

Detects when users are “on-line” and can pass messages such as new voicemails and e-mails to these users.

Billing 174

Provides billing infrastructure such as capturing and processing billable events, rating, and interfaces to external billing systems.

Logging 186

Logs all events sent over the JMS bus 194. Examples include User A of Company ABC accessed Stock Quotes, application server 160 requested driving directions from content service 180, etc.

Location 196

Provides geographic location of caller.

Location service sends a request to the wireless carrier or to a location network service provider such as TimesThree®or US Wireless. The network provider responds with the geographic location (accurate within 75 meters) of the cell phone caller.

Advertising 197

Administers the insertion of advertisements within each call. The advertising service can deliver targeted ads based on user profile information.

Interfaces to external advertising services such as Wyndwire® are provided.

Transactions 198

Provides transaction infrastructure such as shopping cart, tax and shipping calculations, and interfaces to external payment systems.

Notification 199

Provides external and internal notifications based on a timer or on external events such as stock price movements. For example, a user can request that he/she receive a telephone call every day at 8AM.

Services can request that they receive a notification to perform an action at a pre-determined time. For example, the content service 180 can request that it receive an instruction every night to archive old content.

3^{rd} Party Service Adapter 190

Enables 3^{rd} parties to develop and use their own external services. For instance, if a customer wants to leverage a proprietary system, the 3^{rd} party service adapter can enable it as a service that is available to applications.

Presentation Layer 152

The presentation layer 152 provides the mechanism for communicating with the end user. While the application layer 154 manages the application logic, the presentation layer 152 translates the core logic into a medium that a user's device can understand. Thus, the presentation layer 152 enables multi-modal support. For instance, end users can interact with the platform through a telephone, WAP session, HTML session, pager, SMS, facsimile, and electronic mail. Furthermore, as new “touchpoints” emerge, additional modules can seamlessly be integrated into the presentation layer 152 to support them.

Telephony Server 158

The telephony server 158 provides the interface between the telephony world, both Voice over Internet Protocol (VoIP) and Public Switched Telephone Network (PSTN), and the applications running on the platform. It also provides the interface to speech recognition and synthesis engines 153. Through the telephony server 158, one can interface to other 3^{rd} party application servers 190 such as unified messaging and conferencing server. The telephony server 158 connects to the telephony switches and “handles” the phone call.

Features of the telephony server 158 include:

Mission critical reliability.

Suite of operations and maintenance tools.

Telephony connectivity via ISDN/T1/E1, SIP and SS7 protocols.

DSP-based telephony boards offload the host, providing real-time echo cancellation, DTMF & call progress detection, and audio compression/decompression.

Speech Recognition Server 155

The speech recognition server 155 performs speech recognition on real time voice streams from the telephony server 158. The speech recognition server 155 may support the following features:

Carrier grade scalability & reliability

Large vocabulary size

Industry leading speaker independent recognition accuracy

Recognition enhancements for wireless and hands free callers

Dynamic grammar support—grammars can be added during run time.

Multi-language support

Barge in—enables users to interrupt voice applications. For example, if a user hears “Please say a name of a football team that you,” the user can interject by saying “Miami Dolphins” before the system finishes.

Speech objects provide easy to use reusable components

“On the fly” grammar updates

Speaker verification

Audio Manager 157

Manages the prompt server, text-to-speech server, and streaming audio.

Prompt Server 153

The Prompt server is responsible for caching and managing pre-recorded audio files for a pool of telephony servers.

Text-to-Speech Server 153

When pre-recorded prompts are unavailable, the text-to-speech server is responsible for transforming text input into audio output that can be streamed to callers on the telephony server 158. The use of the TTS server offloads the telephony server 158 and allows pools of TTS resources to be shared across several telephony servers.

Features include:

Support for industry leading technologies such as SpeechWorks® Speechify® and L&H RealSpeak®.

Standard Application Program Interface (API) for integration of other TTS engines.

Streaming Audio

The streaming audio server enables static and dynamic audio files to be played to the caller. For instance, a one minute audio news feed would be handled by the streaming audio server.

Support for standard static file formats such as WAV and MP3

Support for streaming (dynamic) file formats such as Real Audio® and Windows® Media®.

PSTN Connectivity

Support for standard telephony protocols like ISDN, E&M WinkStart®, and various flavors of E1 allow the telephony server 158 to connect to a PBX or local central office.

SIP Connectivity

The platform supports telephony signaling via the Session Initiation Protocol (SIP). The SIP signaling is independent of the audio stream, which is typically provided as a G.711 RTP stream. The use of a SIP enabled network can be used to provide many powerful features including:

Flexible call routing

Call forwarding

Blind & supervised transfers

Location/presence services

Interoperable with SIP compliant devices such as soft switches

Direct connectivity to SIP enabled carriers and networks

Connection to SS7 and standard telephony networks (via gateways)

Admin Web Server

Serves as the primary interface for customers.

Enables portal management services and provides billing and simple reporting information. It also permits customers to enter problem ticket orders, modify application content such as advertisements, and perform other value added functions.

Consists of a website with backend logic tied to the services and application layers. Access to the site is limited to those with a valid user id and password and to those coming from a registered IP address. Once logged in, customers are presented with a homepage that provides access to all available customer resources.

Other 168

Web-based development environment that provides all the tools and resources developers need to create their own speech applications.

Provides a VoiceXML Interpreter that is:

Compliant with the VoiceXML 1.0 specification.

Compatible with compelling, location-relevant SpeechObjects—including grammars for nationwide US street addresses.

Provides unique tools that are critical to speech application development such as a vocal player. The vocal player addresses usability testing by giving developers convenient access to audio files of real user interactions with their speech applications. This provides an invaluable feedback loop for improving dialogue design.

WAP, HTML, SMS, Email, Pager, and Fax Gateways

Provide access to external browsing devices.

Manage (establish, maintain, and terminate) connections to external browsing and output devices.

Encapsulate the details of communicating with external device.

Support both input and output on media where appropriate. For instance, both input from and output to WAP devices.

Reliably deliver content and notifications.

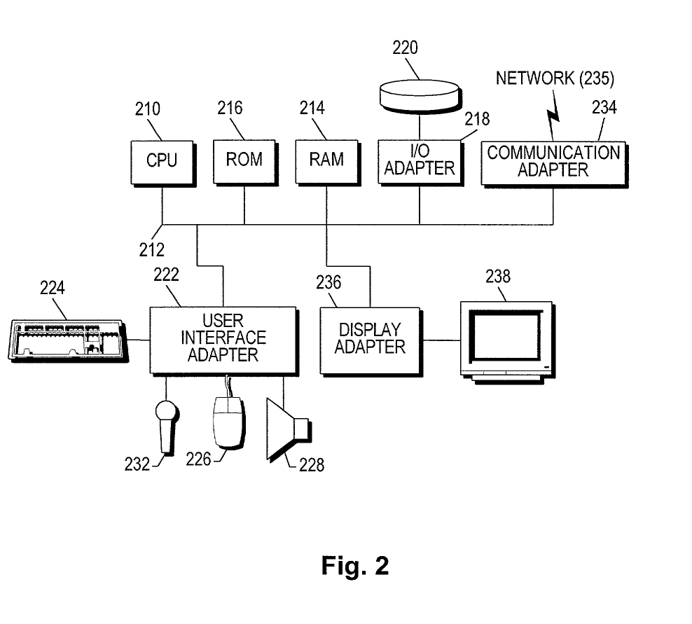

FIG. 2 shows a representative hardware environment associated with the various systems, i.e. computers, servers, etc., of FIG. 1. FIG. 2 illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network (e.g., a data processing network) and a display adapter 236 for connecting the bus 212 to a display device 238. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

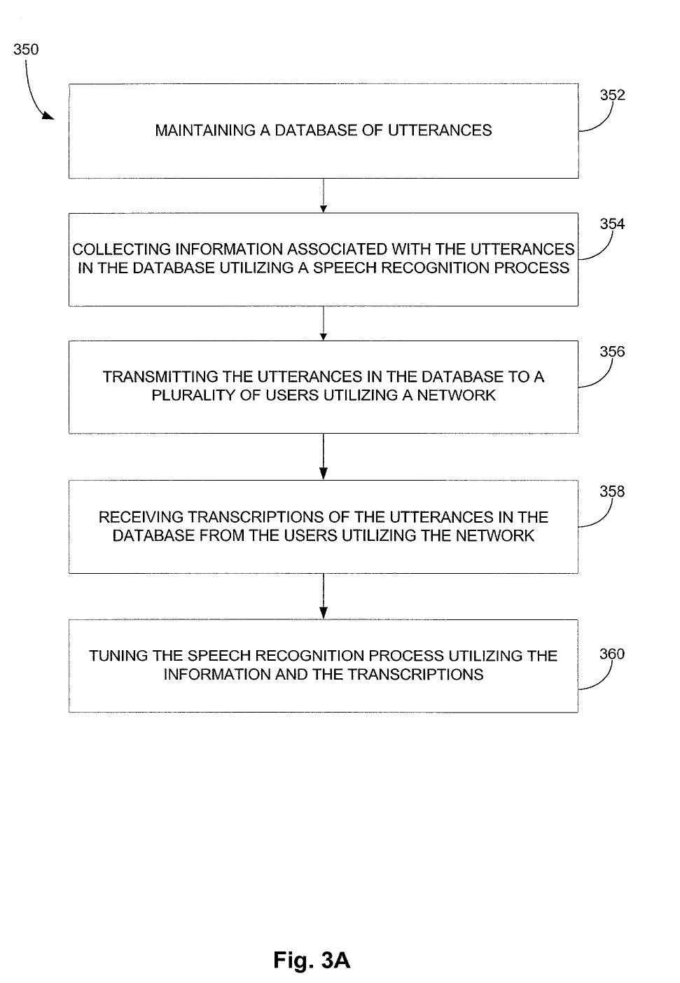

FIG. 3 illustrates a method 350 for providing a speech recognition process. Initially, a database of utterances is maintained. See operation 352. In operation 354, information associated with the utterances is collected utilizing a speech recognition process. When a speech recognition process application is deployed, audio data and recognition logs may be created. Such data and logs may also be created by simply parsing through the database at any desired time.

In one embodiment, a database record may be created for each utterance. Table 1 illustrates the various information that the record may include.

TABLE 1

Name of the grammar it was recognized against;
Name of the audio file on disk;
Directory path to that audio file;
Size of the file (which in turn can be used to calculate the length
of the utterance if the sampling rate is fixed);
Session identifier;
Index of the utterance (i.e. the number of utterances said before in
the same session);
Dialog state (identifier indicating context in the dialog flow in
which recognition happened);
Recognition status (i.e. what the recognizer did with the utterance
(rejected, recognized, recognizer was too slow);
Recognition confidence associated with the recognition result;
Recognition hypothesis;
Gender of the speaker;
Identification of the transcriber; and/or
Date the utterances were transcribed.

Inserting utterances and associated information in this fashion in the database (SQL database) allows instant visibility into the data collected. Table 2 illustrates the variety of information that may be obtained through simple queries.

TABLE 2

Number of collected utterances;
Percentage of rejected utterances for a given grammar;
Average length of an utterance;
Call volume in a give data range;
Popularity of a given grammar or dialog state; and/or
Transcription management (i.e. transcriber's productivity).

Further, in operation 356, the utterances in the database are transmitted to a plurality of users utilizing a network. As such, transcriptions of the utterances in the database may be received from the users utilizing the network. Note operation 358. As an option, the transcriptions of the utterances may be received from the users using a network browser.

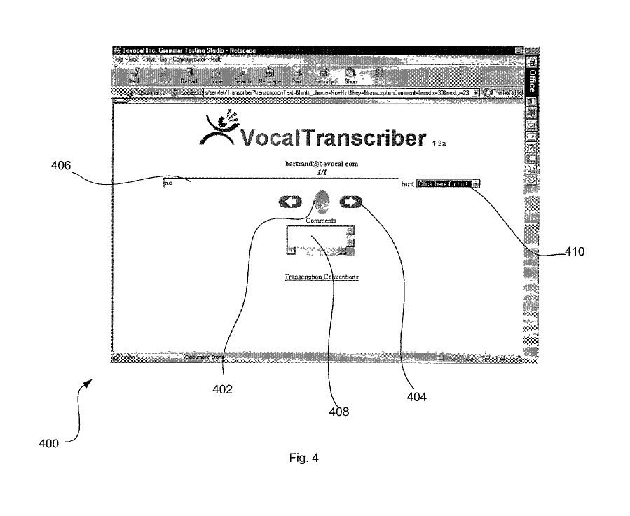

FIG. 4 illustrates a web-based interface 400 that may be used which interacts with the database to enable and coordinate the audio transcription effort. As shown, a speaker icon 402 is adapted for emitting a present utterance upon the selection thereof. Previous and next utterances may be queued up using selection icons 404. Upon the utterance being emitted, a local or remote user may enter a string corresponding to the utterance in a string field 406. Further, comments (re. transcriber's performance) may be entered regarding the transcription using a comment field 408. Such comments may be stored for facilitating the tuning effort, as will soon become apparent.

As an option, the web-based interface 400 may include a hint pull down menu 410. Such hint pull down menu 410 allows a user choose from a plurality of strings identified by the speech recognition process in operation 354 of FIG. 3A. This allows the transcriber to do a manual comparison between the utterance and the results of the speech recognition process. Comments regarding this analysis may also be entered in the comment field 408.

The web-based interface 400 thus allows anyone with a web-browser and a network connection to contribute to the tuning effort. During use, the interface 400 is capable of playing collected sound files to the authenticated user, and allows them to type into the browser what they hear. Making the transcription task remote simplifies the task of obtaining quality transcriptions of location specific audio data (street names, city names, landmarks). The order in which the utterances are fed to the transcribers can be tweaked by a transcription administrator (e.g. to favor certain grammars, or more recently collected utterances). This allows for the transcribers work to be focused on the areas needed.

Similar to the speech recognition process of operation 304 of FIG. 3, the present interface 400 of FIG. 4 and the transcription process contribute information for use during subsequent tuning. Table 3 illustrates various fields of information that may be associated with each utterance record in the database.

TABLE 3

Date the utterance was transcribed;
Identifier of the transcriber;
Transcription text;
Transcription comments noting speech anomalies;
and/or
Gender identifier.

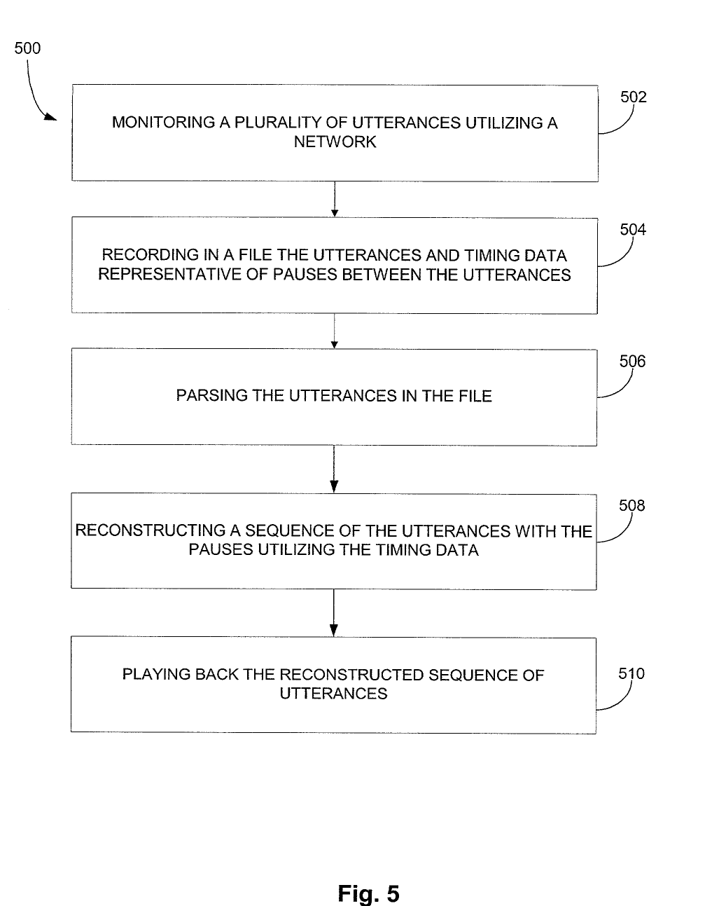

FIG. 5 is a flowchart illustrating a method 500 for recording and playing back an interaction between a user and an automated service. Initially, in operation 502, a plurality of utterances is monitored utilizing a network. This may be accomplished by simply monitoring communications that are taking place over a telecommunication network. Further, in operation 504, the utterances and timing data representative of pauses between the utterances are recorded in a file, i.e. a log file. While the utterances may simply be stored digitally, the pauses may be timed utilizing a timer. As such, a time value and a location (i.e. an identification of the utterances between which the time value was calculated) may be stored in the log file with the utterances.

At a later time, the utterances in the file are parsed so that the utterances may be played back as separate, distinct entities. See operation 506. Once this is accomplished, a sequence of the utterances can be reconstructed with the pauses utilizing the timing data. The reconstructed sequence of utterances is then played back for reasons that will soon be set forth. Note operations 508 and 510.

It should be noted that the utterances may be monitored during an interaction between a user and an automated service. As such, the utterances may include any of those generated by the user and/or the automated service during the interaction. For example, the utterances may include a prompt for the user, a string of user utterances received from the user, and a reply to the string of user utterances. In particular, a user may be prompted with a prompt utilizing network, and the string of user utterances may be received from the user in response to the prompt utilizing the network. Thereafter, a reply to the string of user utterances may be transmitted to the user utilizing the network.

In use, the reconstructed sequence of utterances may be played back for facilitating the tuning of an associated speech recognition process. Note FIGS. 3 and 4. Such speech recognition process may be tuned by identifying utterances that are difficult to recognize, and generating alternate phonetic spellings.

In another embodiment of the present invention, the utterances of the sequence may each represent a state. Note Table 1. In particular, the user may be prompted to enter certain types of information in a certain order and/or at a certain time. For example, a user may be prompted to enter a city name, a street name, and a person's name. In such case, a first utterance would be given a state associated with the city name, a second utterance would be given a state associated with the street name, and a third utterance would be given a state associated with the person's name. By this design, the user may selectively access utterances associated with only a predetermined state.

As an option, the utterances of the sequence may be capable of being selectively played back without the pauses. This allows accelerated review of the utterances for testing and tuning purposes. As yet another option, the utterances of the sequence may be capable of being selectively played back based on a user who submitted the utterances, a time the utterances were submitted, and/or an application in association with which the utterances were submitted. Such user-configurable criteria provides a dynamic method of accessing and analyzing utterances in order to enhance a speech recognition process.

In yet another embodiment of the present invention, any difficulty of the speech recognition process with recognizing the utterances may be detected. For example, the present invention may be capable of detecting a situation where a user was prompted to submit an utterance multiple instances because of a failure of the speech recognition process. In such scenario, someone, i.e. an administrator, may be notified of the difficulty, and the sequence of utterances may be played back for analysis purposes.

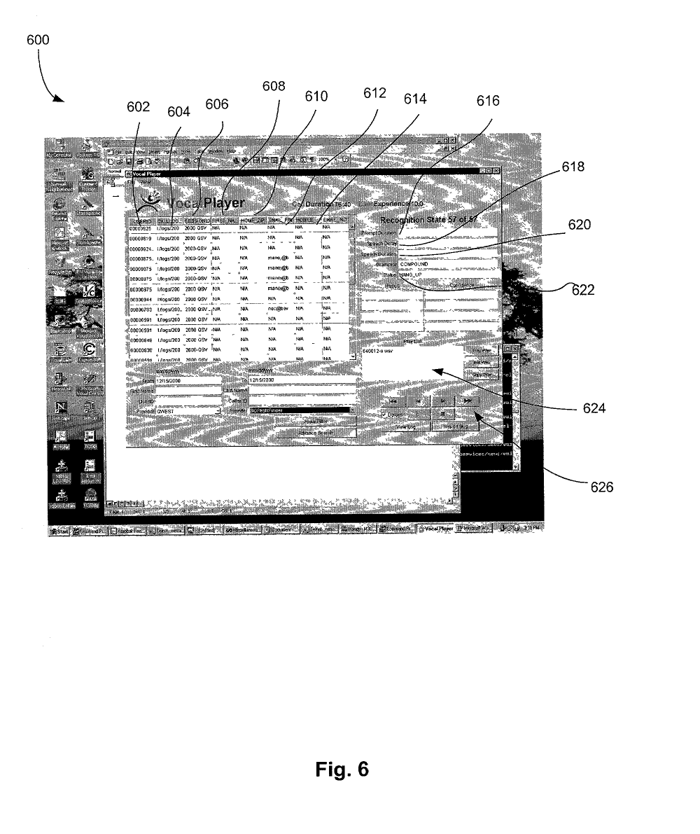

FIG. 6 illustrates a graphical user interface 600 for allowing a user to selectively play back utterances, in accordance with one embodiment of the present invention. The present graphical user interface 600 operates as a central interface for playing back the utterances. With such interface 600, a user is capable of playing back selected portions or a complete recording of a user session.

As shown, the interface 600 displays various information regarding the utterances including, a user identifier 602, a call log 604, a session identifier 606, and various information relating to the user including, but not limited to a first name 608, zip code 610, electronic mail address 612, mobile phone 614, etc. Further information is displayed including the duration of the utterance 616, delay of speech 618, duration of speech 620, and status 622. Also shown is a play list 624, along with a plurality of control icons 626 for playing, fast forwarding, rewinding, pausing, and stopping, etc.

The user identifier 602 refers to a number assigned to each user. The call log 604 refers to a unique number associated with each call. The session identifier 606 is a database key to identify a call. As shown, the remaining records of the call are displayed in columnar fashion.

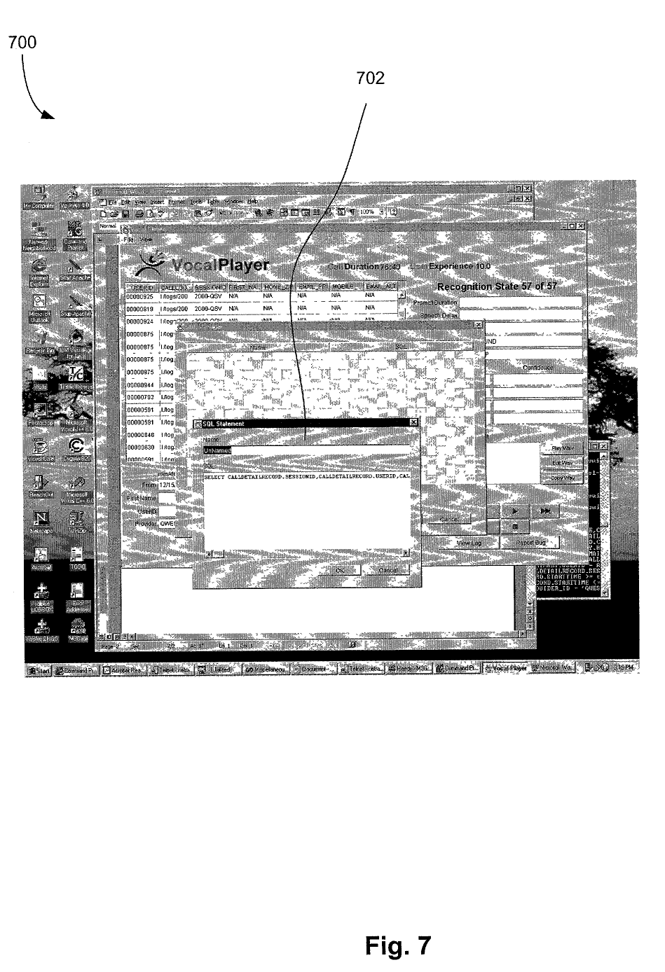

FIG. 7 illustrates a graphical user interface 700 for searching for stored utterances. Ideally, the graphical user interface 700 shows a SQL query box 702 for an advanced search of a saved user session. The standard searches may be done by the search criteria appearing at the bottom of the display. However, advanced search allows the full power of a SQL query to select items.

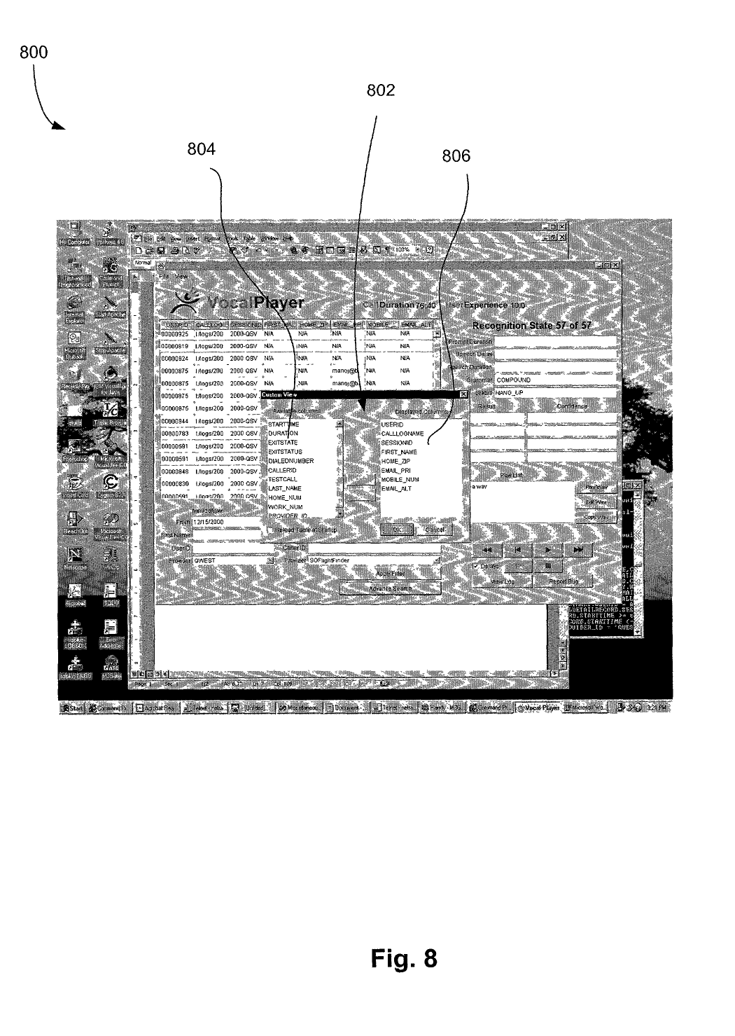

FIG. 8 illustrates a graphical user interface 800 by which a user can configure the interface 600 of FIG. 6. In particular, a dialog box 802 is displayed that shows a first box 804 including all of the information that is available regarding each sequence of utterances. Further shown is a second box 806 including all of the information that is currently displayed by interface 600 of FIG. 6. With the current graphical user interface 800, a user may select which information is to be displayed by the main interface 600.

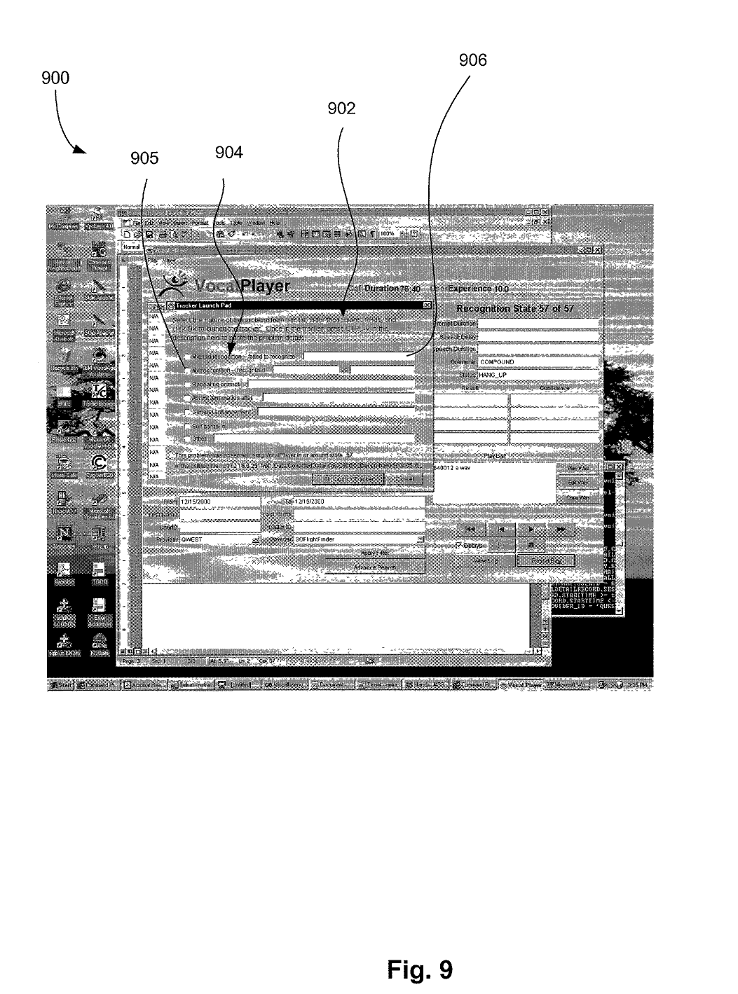

FIG. 9 illustrates a graphical user interface for tagging a bug to be fixed. As shown in FIG. 9, a dialog box 902 is provided including a plurality of possible “bugs” 904 that are listed each with a check box 905 positioned adjacent thereto. A user may check each check box 905 that is applicable. Examples of such bugs are shown in Table 4.

TABLE 4

Missed Recognition
Misrecognition
Repeating Prompt
Abrupt Termination
General Enhancement
Other

Also included in the dialog box 902 is a plurality of fields 906 for allowing the user to elaborate on each of the bugs by entering a textual description.

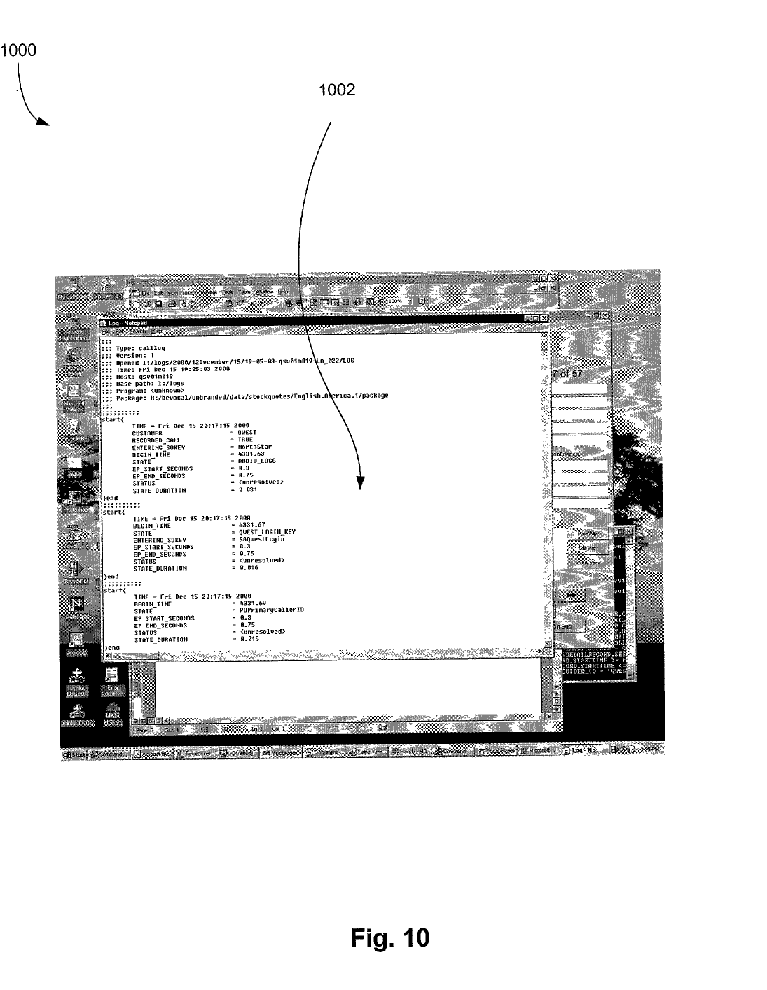

FIG. 10 illustrates a graphical user interface 1000 that shows the manner in which the various logs 1002 associated with each call may be displayed. It should be noted that each log includes, but is not limited to all of the information mentioned hereinabove, i.e. user identifier, a call log, a session identifier, a first name of the user, zip code of the user, electronic mail address of the user, mobile phone of the user, duration of the utterance, delay of speech, duration of speech, status, etc. In one embodiment, the call logs 1002 may be illustrated utilizing a text editor such as Microsoft® Notepad® or the like.

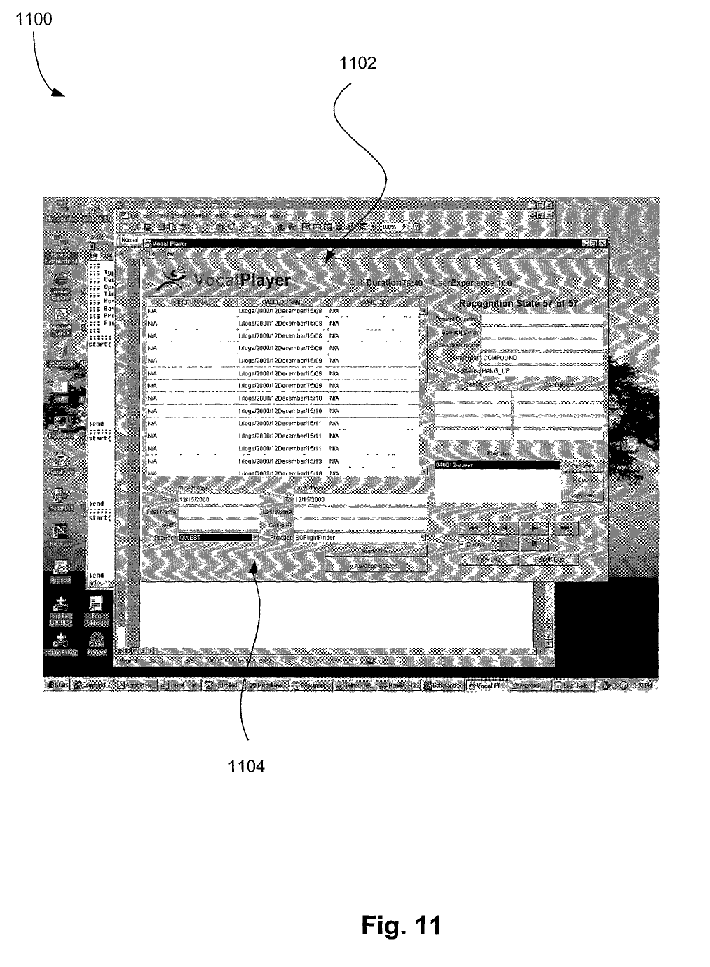

FIG. 11 illustrates the manner 1100 in which the columns and rows 1102 of the main graphical user interface can be sorted interactively to determine a particular call to utilize, and how any of the fields can be dynamically resized. The various criteria 1104 at the bottom of the main graphical user interface can be used to select the appropriate wave form file to utilize as input.

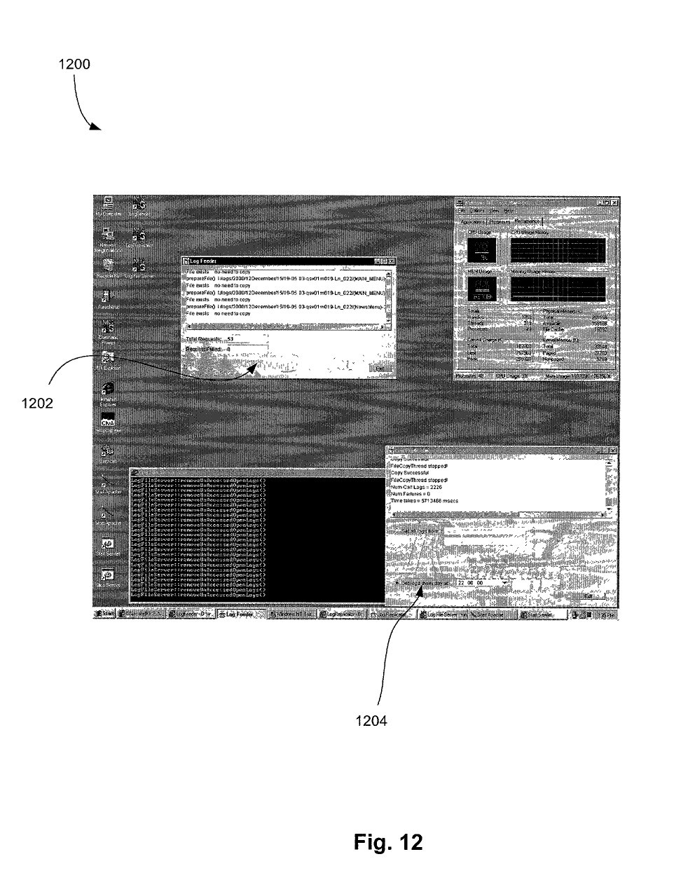

FIG. 12 illustrates a graphical user interface 1200 that includes a log feeder 1202 and a log replicator 1204. In operation, the log feeder 1202 is used to manage the call log file. Further, the log replicator 1204 replicates the log from a centralized source for viewing, editing, etc.

Following is an exemplary call log:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for recording and playing back a sequence of utterances, comprising:
(a) monitoring a plurality of utterances utilizing a network;
(b) recording in a file the utterances and timing data representative of pauses between the utterances;
(c) parsing the utterances in the file;
(d) reconstructing a sequence of the utterances with the pauses utilizing the timing data; and
(e) playing back the reconstructed sequence of utterances.

2. A method as set forth in claim 1, wherein the utterances are played back based on user-configured criteria.

3. The method as recited in claim 1, wherein the reconstructed sequence of utterances are played back for facilitating the tuning of an associated speech recognition process.

4. The method as recited in claim 3, wherein the speech recognition process is tuned by identifying utterances that are difficult to recognize, and generating alternate phonetic spellings.

5. The method as recited in claim 3, wherein the utterances of the sequence each represent a state, and utterances are played back based on the state thereof.

6. The method as recited in claim 3, wherein the utterances of the sequence are capable of being selectively played back without the pauses.

7. The method as recited in claim 3, wherein the utterances of the sequence are capable of being selectively played back based on a user who submitted the utterances.

8. The method as recited in claim 3, wherein the utterances of the sequence are capable of being selectively played back based on a time the utterances were submitted.

9. The method as recited in claim 3, wherein the utterances of the sequence are capable of being selectively played back utilizing a network.

10. The method as recited in claim 3, wherein the utterances of the sequence are capable of being selectively played back based on an application in association with which the utterances were submitted.

11. The method as recited in claim 1, and further comprising the step of detecting a difficulty of a speech recognition process in recognizing the utterances.

12. The method as recited in claim 11, wherein an administrator is notified of the difficulty, and the sequence of utterances are played back thereto.

13. The method as recited in claim 1, wherein the utterances of the sequence are capable of being selectively played back utilizing a graphical user interface.

14. A computer program product for recording and playing back a sequence of utterances, comprising:
(a) computer code for monitoring a plurality of utterances utilizing a network;
(b) computer code for recording in a file the utterances and timing data representative of pauses between the utterances;
(c) computer code for parsing the utterances in the file;
(d) computer code for reconstructing a sequence of the utterances with the pauses utilizing the timing data; and
(e) computer code for playing back the reconstructed sequence of utterances.

15. A system for recording and playing back a sequence of utterances, comprising:
(a) logic for monitoring a plurality of utterances utilizing a network;
(b) logic for recording in a file the utterances and timing data representative of pauses between the utterances;
(c) logic for parsing the utterances in the file;
(d) logic for reconstructing a sequence of the utterances with the pauses utilizing the timing data; and
(e) logic for playing back the reconstructed sequence of utterances.

16. A method for recording and playing back an interaction between a user and an automated service, comprising:
(a) prompting a user with a prompt utilizing a network;
(b) receiving a string of user utterances from the user in response to the prompt utilizing the network;
(c) transmitting a reply to the string of user utterances to the user utilizing the network;
(d) recording in a file the prompt, the string of user utterances, the reply, and timing data representative of pauses between the prompt, the string of user utterances, and the reply;
(e) reconstructing an accurate sequence of the prompt, the string of user utterances, and the reply with the pauses utilizing the timing data; and
(f) playing back the reconstructed sequence.

17. A method for recording and playing back a string of utterances for facilitating the tuning of a speech recognition process, comprising:
(a) monitoring a string of utterances utilizing a network, the string of utterances being monitored during an interaction between a user and an automated service;
(b) recording in a file the string of utterances and timing data representative of pauses between the utterances;
(c) reconstructing the string of utterances with the pauses utilizing the timing data; and
(d) playing back the reconstructed string of utterances, wherein the reconstructed string of utterances are played back for facilitating the tuning of an associated speech recognition process.
